(19) United States
(12) Patent Application Publication
(10) Pub. No.: US 2020/0301747 A1
(43) Pub. Date: Sep. 24, 2020

(54) CONTROL METHOD, CONTROL APPARATUS AND SERVER IN NETWORK SYSTEM

(71) Applicant: NEC CORPORATION, Tokyo (JP)

(72) Inventors: Satoru ISHII, Tokyo (JP); Shintaro NAKANO, Tokyo (JP); Hideo HASEGAWA, Tokyo (JP); Seiya SHIBATA, Tokyo (JP)

(73) Assignee: NEC CORPORATION, Tokyo (JP)

(21) Appl. No.: 16/088,186

(22) PCT Filed: Mar. 27, 2017
(86) PCT No.: PCT/JP2017/012223

§ 371 Date: Sep. 25, 2018

(30) Foreign Application Priority Data
Mar. 31, 2016 (JP) 2016-070569

(51) Int. Cl. G06F 9/50; G06F 9/455

(52) U.S. Cl. CPC G06F 9/5077; G06F 2009/45595; G06F 9/45558

(57) ABSTRACT

A control method, a control apparatus, a network system, and a server, for efficiently controlling a network including programmable logical circuits as a VM/VNF infrastructure, are provided. A control apparatus (10), for a network including servers on which virtual network functions operate, includes a storage means (102, 103) that stores a correspondence relation among a programmable logic circuit included in a server, a virtual machine operating on the server, and a virtual network function implemented by the virtual machine of the server, and a control means (106) that controls at least the virtual machine and the programmable logic circuit on which the virtual machine operates, based on the correspondence relation.

### TECHNICAL FIELD

The present invention relates to a network system including virtual network functions, and in particular, to control techniques of the network system.

### BACKGROUND ART

In current communication systems, various network functions (NFs) such as broadband remote access server (BRAS), network address translation (NAT), router, firewall (FW), and deep packet inspection (DPI) are implemented by dedicated hardware (appliances). As such, when launching a new network service, a network operator is forced to introduce new dedicated hardware appliances. This requires significant costs for purchasing appliances, installation spaces, and the like. In view of such a situation, consideration is given to a technology of virtually implementing network functions implemented by hardware, by software (network function virtualization), recently (Non-Patent Literature 1). As an example of network service virtualization, Patent Literature 1 discloses a method in which a plurality of virtual routers are constructed on communication node devices, and resources of the virtual routers are dynamically distributed according to the communication quality.

Further, a technology of providing various network services by transferring a communication flow to a communication path in which a plurality of virtual network functions (VNFs) are combined is also considered (See Non-Patent Literature 2, for example).

As illustrated in FIG. 1, in network function virtualization, network services are configured and managed by logical links (forwarding graph) of virtual network functions (VNF). In this example, a network service including five virtual network functions VNF-1 to VNF-5 is illustrated in an overlay network.

The virtual network functions VNF-1 to VNF-5 in the forwarding graph operate on general-purpose servers SV1 to SV4 in the NFV infrastructure (NFVI). By operating carrier grade functions on general-purpose servers rather than dedicated servers, it is possible to achieve cost reduction and easy operation.

### CITED LITERATURE

[Patent Literature 1] JP 2012-175418 A
[Non-Patent Literature 1] Network Functions Virtualization—Update White Paper, Oct. 15-17, 2013 at the “SDN and OpenFlow World Congress”, Frankfurt-Germany (http://portal.etsi.org/NFV/NFV_White_Paper2.pdf)
[Non-Patent Literature 2] ETSI GS NFV 001 v1.1.1 (2013-10) “Network Functions Virtualization (NFV); Use Cases” (http://docbox.etsi.org/ISG/NFV/Open/Published/gs_NFV001v010101p%20-%20Use %20Cases.pdf)

### SUMMARY OF THE INVENTION

However, when attempting to construct NFV by general-purpose servers, there is a case where a bottleneck occurs in CPU (central processing unit) processing of a server, communication between servers, and the like. In order to prevent such a bottleneck, it is indispensable to achieve high-speed processing of the servers. As a technology of accelerating CPU processing, in addition to an increase of the number of CPU cores, an accelerator technology of connecting a field-programmable gate array (FPGA) to a CPU has been known (for example, “Xeon+FPGA Platform for the Data Center” ISCA/CARL 2015 <http://www.ece.cmu.edu/˜calcm/carl/lib/exe/fetch.php?media=carl15-gupta.pdf>).

However, in the case of constructing NFV with use of such a server to which an FPGA is added, a VM/VNF operates not only on the CPU but also on the FPGA. Accordingly, it is necessary to manage a correspondence between the FPGA and the VM in the network. For example, it is necessary to perform update of a FPGA program depending on a VM, and perform addition/update of an FPGA according to addition/update of a VM due to update of a VM such as version upgrade or addition of a VNF.

As described above, in a network including not only CPUs of servers but also programmable logic circuits such as FPGAs as a VM/VNF infrastructure, it is necessary to have a special control system in consideration of programmable logic circuits.

In view of the above, an exemplary object of the present invention is to provide a control method, a control apparatus, a network system, and a server, for efficiently controlling a network including programmable logical circuits as a VM/VNF infrastructure.

A control apparatus according to an exemplary aspect of the present invention is a control apparatus for a network including servers on which virtual network functions operate. The control apparatus includes a storage means that stores a correspondence relation among a programmable logic circuit included in a server, a virtual machine operating on the server, and a virtual network function implemented by the virtual machine of the server; and a control means that controls at least the virtual machine and the programmable logic circuit on which the virtual machine operates, based on the correspondence relation.

A network control method according to an exemplary aspect of the present invention is a control method for a network including servers on which virtual network functions operate. The method includes, by a storage means, storing a correspondence relation among a programmable logic circuit included in a server, a virtual machine operating on the server, and a virtual network function implemented by the virtual machine of the server, and by a control means, controlling at least the virtual machine and the programmable logic circuit on which the virtual machine operates, based on the correspondence relation.

A network system according to an exemplary aspect of the present invention is a network system including servers on which virtual network functions operate. The network system includes a network in which a plurality of servers, including at least one server supporting a programmable logic circuit, are connected with each other, and a control apparatus. The control apparatus that, based on a correspondence relation among a programmable logic circuit included in a server, a virtual machine operating on the server, and a virtual network function implemented by the virtual machine of the server, controls at least the virtual machine and the programmable logic circuit on which the virtual machine operates.

According to the present invention, it is possible to efficiently control a network including programmable logic circuits as a VM/VNF infrastructure.

### BRIEF DESCRIPTION OF THE DRAWINGS

FIG. 1 is a schematic network diagram illustrating an example of virtualization of network functions.

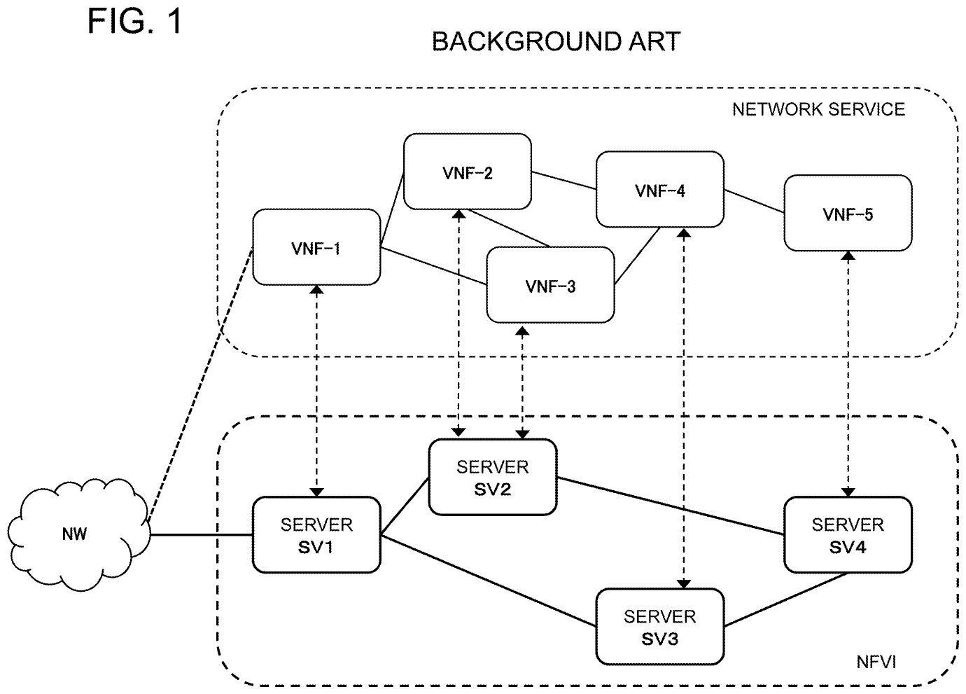

FIG. 2 is a schematic network diagram illustrating a first example of a network system to which the present invention is applied.

FIG. 3 is a schematic network diagram illustrating a correspondence relation between physical servers and virtual network functions in a network system to which the present invention is applied.

FIG. 4 is a block diagram illustrating a schematic configuration of a control apparatus according to a first exemplary embodiment of the present invention.

FIG. 5 is a network configuration diagram illustrating an exemplary network system according to the present invention.

FIG. 6 is a network configuration diagram for explaining an operation of controlling a network system according to the present invention.

FIG. 7A is a schematic diagram illustrating exemplary management data of a function management unit in the network system illustrated in FIG. 6.

FIG. 7B is a schematic diagram illustrating exemplary management data of an FPGA management unit in the network system illustrated in FIG. 6.

FIG. 8 is a network configuration diagram for explaining a first example of a control operation in the network system according to the present embodiment.

FIG. 9A is a schematic diagram illustrating exemplary management data of a function management unit in the network system illustrated in FIG. 8.

FIG. 9B is a schematic diagram illustrating exemplary management data of an FPGA management unit in the network system illustrated in FIG. 8.

FIG. 10 is a network configuration diagram for explaining a second example of a control operation in the network system according to the present embodiment.

FIG. 11 is a schematic diagram illustrating exemplary management data of an FPGA management unit in the network system illustrated in FIG. 10.

FIG. 12 is a network configuration diagram for explaining a third example of a control operation in the network system according to the present embodiment.

FIG. 13 is a block diagram illustrating a schematic configuration of an FPGA-equipped server.

FIG. 14 is a sequence chart of the control operation illustrated in FIG. 12.

FIG. 15 is a schematic network diagram illustrating a second example of a network system to which the present invention is applied.

FIG. 16 is a schematic network diagram illustrating a third example of a network system to which the present invention is applied.

### EXEMPLARY EMBODIMENTS

### Outline of Exemplary Embodiments

According to exemplary embodiments of the present invention, in a network system in which virtual network functions (VNFs) can operate on servers, a network is controlled with use of a correspondence relation between a programmable logical circuit included in a server, a virtual machine (VM) operating on the server, and a VNF implemented by the VM of the server. For example, by referring to information indicating which server supports a programmable logic circuit, what program is installed in a programmable logic circuit, and which VM and which VNF operate on which server, it is possible to identify a VM and/or a programmable logic circuit that should be updated. As described above, by using information regarding a programmable logic circuit and VM/VNF information associated therewith, it is possible to control update of a circuit configuration program of a programmable logic circuit, addition/update of a programmable logic circuit according to addition/update of a VM, and the like, allowing efficient control of a network including programmable logic circuits.

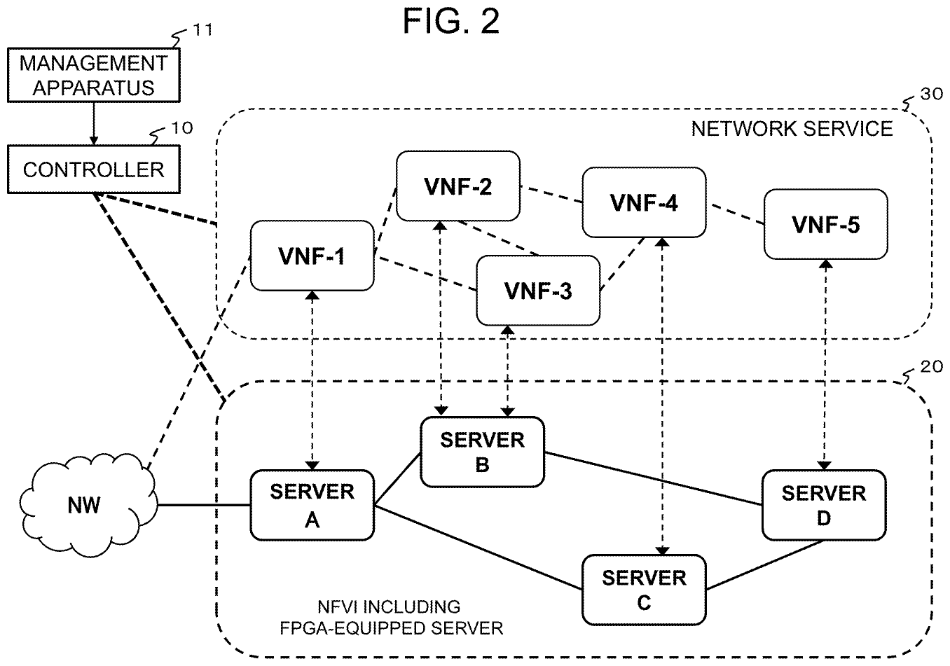

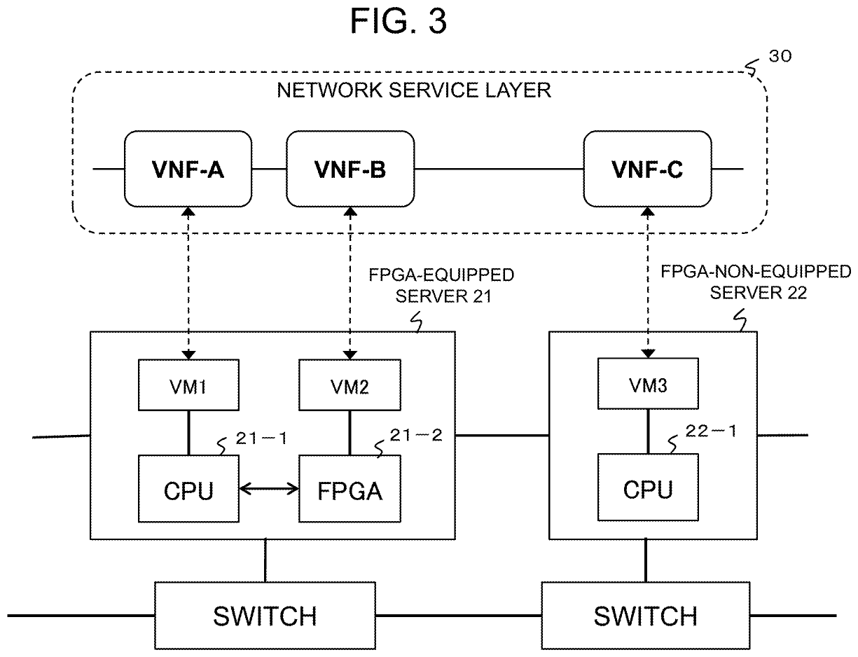

First, an exemplary system configuration for explaining respective exemplary embodiments of the present invention will be described with reference to FIGS. 2 and 3. The system configuration is a simplified example for preventing complicated description, and is not intended to limit the present invention.

### <System>

As illustrated in FIG. 2, a controller 10 controls a lower-layer network 20 including a plurality of servers, and an upper-layer network 30 including a plurality of VNFs, according to an instruction from a management apparatus 11. In this example, it is assumed for simplicity that the lower-layer network 20 includes servers A, B, C, and D, and the upper-layer network 30 includes virtual network functions VNF-1 to VNF-5.

At least one of the servers in the lower-layer network 20 is a server including a programmable logic circuit. As described below, a programmable logic circuit is a hardware circuit capable of performing programmable routine processing at a high speed, and is operable as an accelerator of a connected CPU. Further, a programmable logic circuit is able to implement a user-desired logic function in a short period of time, and also has an advantage that it is rewritable. Hereinafter, an FPGA is shown as an example of a programmable logic circuit. A server in which a CPU and an FPGA are connected with each other is called an FPGA-equipped server, and a server having no FPGA is called an FPGA-non-equipped server.

Each VNF in the upper-layer network 30 is set on a physical server of the lower-layer network 20. For example, in the system illustrated in FIG. 2, the VNF-1, the VNF-4, and the VNF-5 are set on the server A, the server C, and the sever D, respectively, and the VNF-2 and the VNF-3 are set on a single physical server B. The management apparatus 11 determines how to deploy VNFs on FPGA-equipped servers and FPGA-non-equipped servers. FIG. 3 illustrates an exemplary deployment of VNFs.

In FIG. 3, an FPGA-equipped server 21 in the lower-layer network 20 has a configuration in which a CPU 21-1 and an FPGA 21-2 are connected with each other. In FIG. 3, a virtual machine VM1 is configured on the CPU 21-1 and a virtual machine VM2 is configured on the FPGA 21-2, respectively. A VNF-A in the upper-layer network 20 is deployed on the virtual machine VM1, and a VNF-B is deployed on the virtual machine VM2 on the FPGA 21-2, respectively. The FPGA 21-2 is able to reconfigure a desired VNF by loading configuration data via a device for controlling the FPGA-equipped server 21, such as the controller 10. It is also possible to configure a plurality of virtual machines VM on the CPU 21-1 or the FPGA 21-2, and to deploy a VNF on each of the virtual machines. An FPGA-non-equipped server 22 has a single CPU 22-1, and one or more virtual machines VM3 may be configured thereon, and a VNF may be deployed thereon.

In the network system as described above, the controller 10 is able to individually perform control such as addition, setting change, and deletion of a VNF, a VM, and an FPGA in an FPGA-equipped server and an FPGA-non-equipped server, in accordance with an instruction from the management apparatus 11. While the controller 10 can collectively manage the network system as described above, it is also possible to have a configuration including controllers for respective layers such that a controller controls the upper-layer network 30 (VNF layer) and another controller controls the lower-layer network 20 (NFVI layer). Hereinafter, the controller 10 according to exemplary embodiments of the present invention will be described in detail with reference to the drawings.

### 1. First Exemplary Embodiment

### 1.1) Control Apparatus

A controller 10 according to a first exemplary embodiment of the present invention controls servers and switches in a network system, and performs control of FPGAs, VMs, or VNFs and path control, according to an instruction from the management apparatus 11.

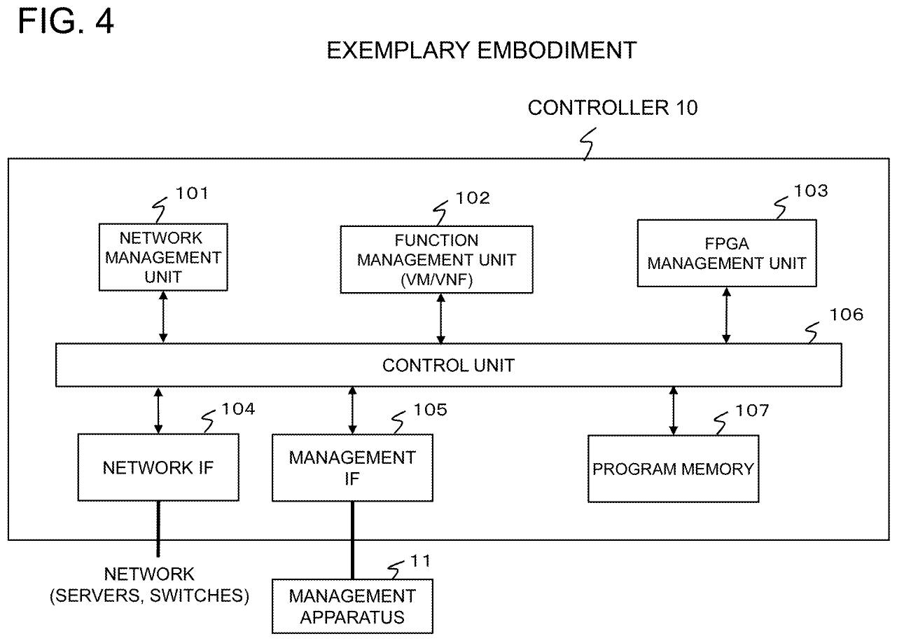

Referring to FIG. 4, the controller 10 includes a network management unit 101, a function management unit 102, and an FPGA management unit 103. The controller 10 also includes a network interface 104 that connects to each of servers and switches in the network system. The controller 10 is connected via a management interface 105 to the management apparatus 11 which is operated by an operator. A control unit 106 of the controller 10 executes programs stored in a program memory 107 to control the network management unit 101, the function management unit 102, and the FPGA management unit 103, and perform control such as addition, change, and deletion of a VM/FPGA.

The network management unit 101 manages information of a network including servers and switches, for instance topology information. The function management unit 102 manages functions operating on respective servers, that is, virtual machines VMs and virtual network functions VNFs. For example, the function management unit 102 manages which VM is operating on which server. The FPGA management unit 103 manages an FPGA of each server. For instance, the FPGA management unit 103 manages which server is FPGA-equipped and which FPGA program is installed.

The control unit 106 controls a forwarding path of the network service based on information managed by the management units 101 to 103. For example, the control unit 106 identifies a path of the upper-layer network 30 based on function information from the function management unit 102 and topology information from the network management unit 101. The control unit 106 also identifies a correspondence relation between a VM and an FPGA to be updated, based on information related to FPGAs from the FPGA management unit 103 and function information from the function management unit 102.

### 1.2) System Configuration

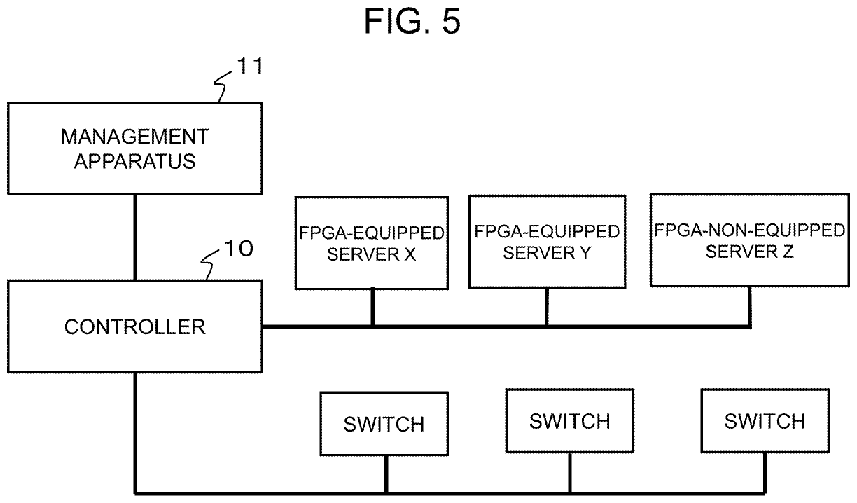

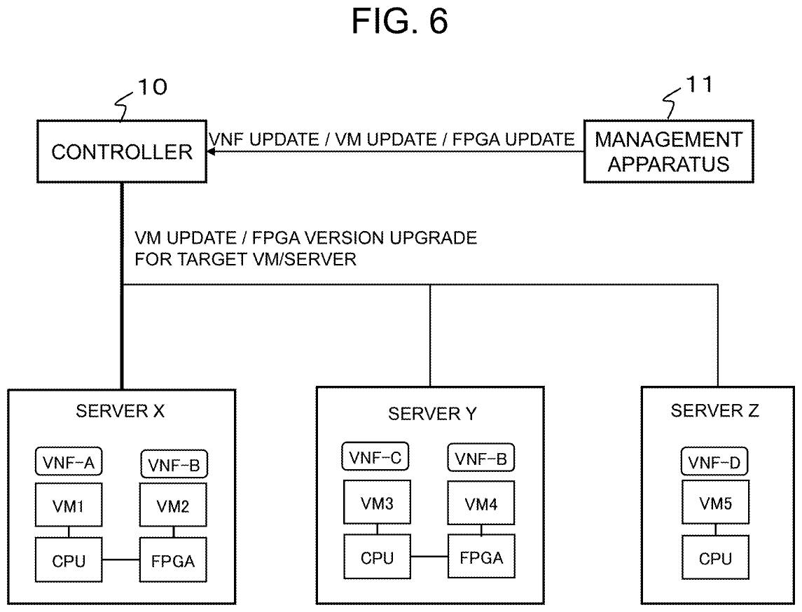

Hereinafter, description will be given on a control method according to the present embodiment with reference to the system illustrated in FIG. 5, in order to avoid complication of description. Accordingly, it is assumed that servers X and V are FPGA-equipped, and a server Z is FPGA-non-equipped, and that the controller 10 controls VMs/FPGAs of respective servers and respective switches according to an instruction from the management apparatus 11. FIG. 6 illustrates a configuration for explaining a specific example of control.

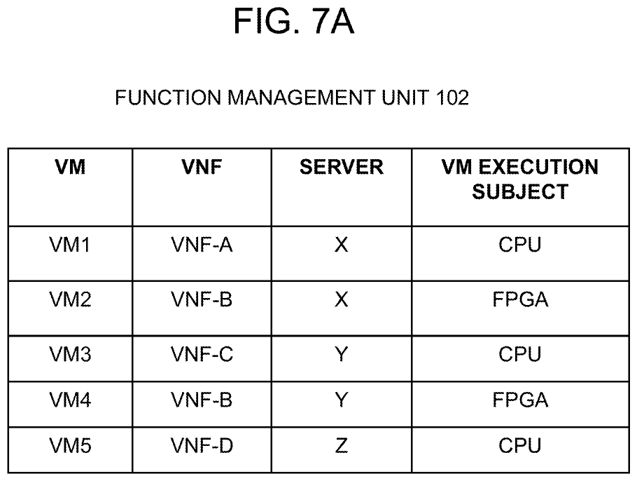

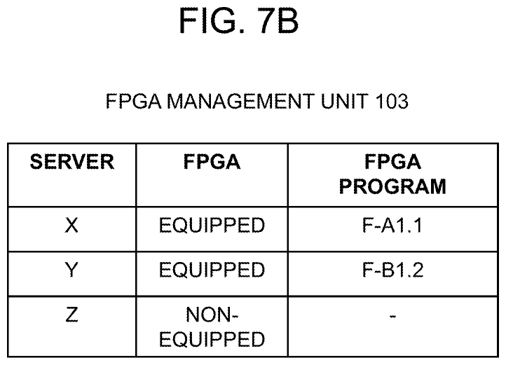

As illustrated in FIG. 6, it is assumed that a virtual network function is deployed on each of the servers X, Y, and Z. In more detail, the virtual machine VM1 is configured on the CPU of the FPGA-equipped server X, and the virtual machine VM2 is configured on the FPGA of the FPGA-equipped server X. The virtual network function VNF-A is deployed on the virtual machine VM1, and the virtual network function VNF-B is deployed on the virtual machine VM2. The virtual machine VM3 is configured on the CPU of the FPGA-equipped server Y, and the virtual machine VM4 is configured on the FPGA of the FPGA-equipped server Y. The virtual network function VNF-C is deployed on the virtual machine VM3, and the virtual network function VNF-B is deployed on the virtual machine VM4. The virtual machine VM5 is configured on the CPU of the FPGA-non-equipped server Z, and the virtual network function VNF-D is deployed on the virtual machine VM5. In such a system, when the management apparatus 11 instructs the controller 10 to update a VNF, a VM, or an FPGA, the controller 10 identifies a target server and VM through the function management unit 102 and the FPGA management unit 103, and performs update of the instructed VNF or VM or version upgrade of the instructed FPGA program. In the function management unit 102 and the FPGA management unit 103, management tables as illustrated in FIGS. 7A and 7B are stored.

As illustrated in FIG. 7A, the function management unit 102 has a management table which registers correspondence relations among the VMs, the VNFs, the servers, and the VM execution subjects of the servers in the network system. This means that by referring to the management table of the function management unit 102, it is possible to identify which of the virtual machines VM1 to VM5 operating in the network system is operating on which execution subject (CPU or FPGA) of which server, and which VNF is operating on the virtual machine.

Further, as illustrated in FIG. 7B, the FPGA management unit 103 has a management table in which FPGA information is registered. The FPGA information includes whether or not each server in the network system is FPGA-equipped, and which FPGA program is installed in each FPGA. For example, the server X is FPGA-equipped, and an FPGA program F-A1.1 is installed therein.

The controller 10 of the present embodiment can use the aforementioned management tables of the function management unit 102 and the FPGA management unit 103 to control the network/VNF/VM/FPGA.

It should be noted that in the controller 10, the functions of the network management unit 101, the function management unit 102, the FPGA management unit 103, and the control unit 105 as described below may also be realized by executing programs, stored in the program memory 107, on the CPU. Hereinafter, examples of the aforementioned VM/FPGA control will be described with reference to the drawings.

### 1.3) Control Operation

### <VNF Update>

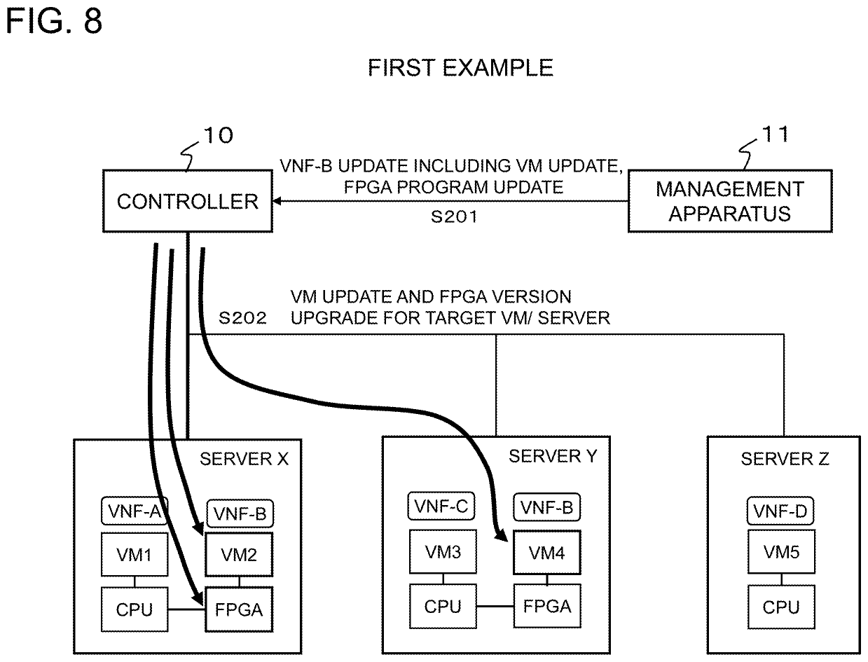

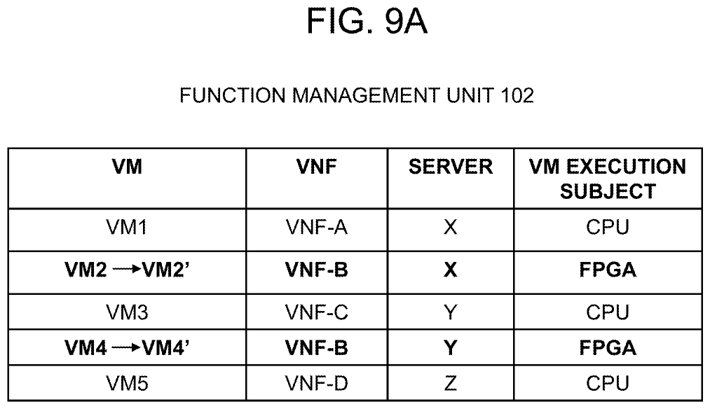

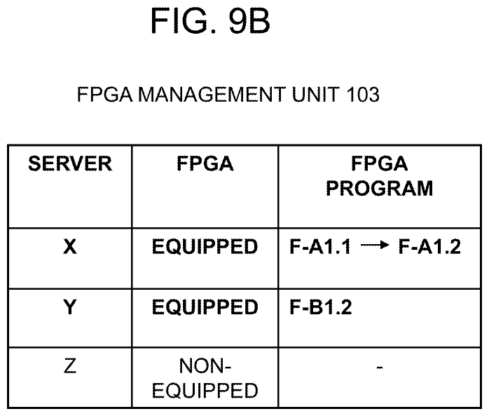

As illustrated in FIG. 8, when receiving an instruction to update the VNF-B including VM update and version upgrade of the FPGA program F-A1.1 from the management apparatus 11 (operation S201), the control unit 106 of the controller 10 refers to the management table of the function management unit 102 to identify the FPGA and the VM2 of the server X associated with the VNF-B and the FPGA and the VM4 of the server Y associated with the VNF-B. The control unit 106 also refers to the management table of the FPGA management unit 103 to identify the program F-A1.1 of the server X. Then, the control unit 106 updates the VM2 of the target server X to VM2′, upgrades the version of the FPGA program from F-A1.1 to F-A 1.2, and updates the VM4 of the server Y to VM4′, via the network interface 104 (operation S202). When completing the update described above, the control unit 106 updates the management tables of the function management unit 102 and the FPGA management unit 103 as illustrated in FIGS. 9A and 9B.

Addition or deletion of a VM is also controllable similarly. For example, in the case of adding a new VM to the server X, the control unit 106 instructs the target server X to add the new VM, via the network interface 104. Meanwhile, in the case of deleting the VM2 from the server X, for example, the control unit 106 instructs the target server X to delete the VM2, via the network interface 104.

### <FPGA Program Update>

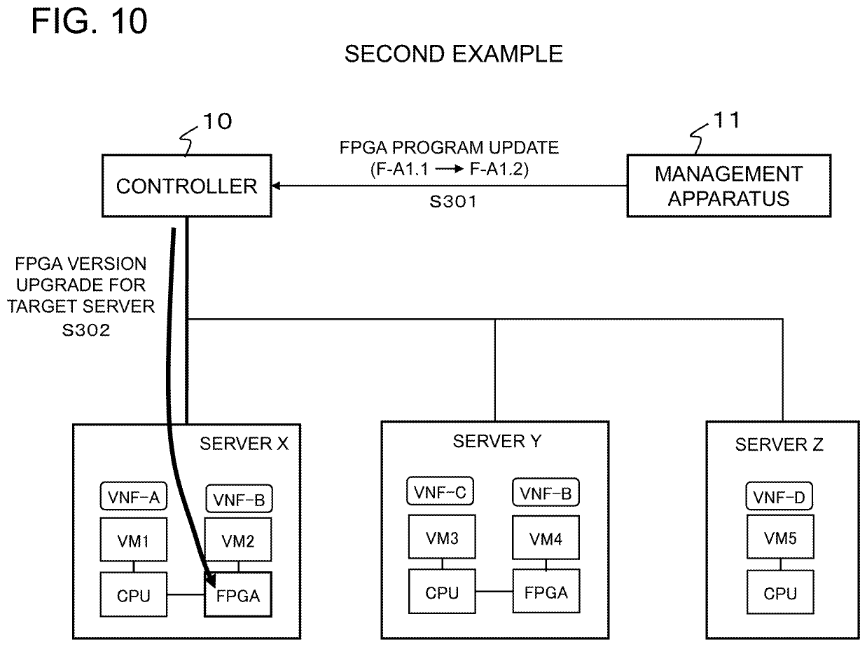

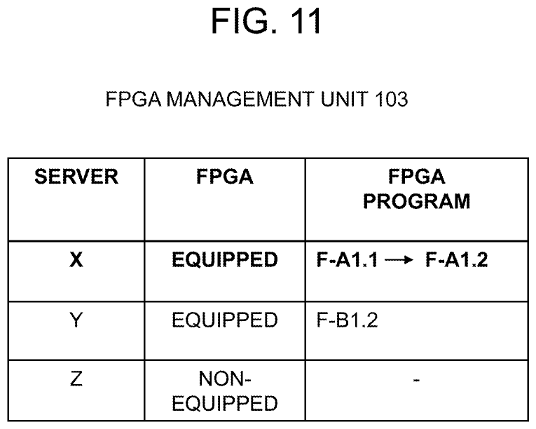

As illustrated in FIG. 10, when receiving an instruction to perform version upgrade of the FPGA program F-A1.1 from the management apparatus 11 (operation S301), the control unit 106 of the controller 10 refers to the management table of the FPGA management unit 103 to identify the FPGA program F-A1.1 of the server X. Then, the control unit 106 upgrades the version of the FPGA program of the target server X from F-A1.1 to F-A1.2, via the network interface 104 (operation S302). When completing the update described above, the control unit 106 updates the management table of the FPGA management unit 103 as illustrated in FIG. 11.

Addition or deletion of an FPGA is also controllable similarly. For example, in the case of adding a new FPGA to the server X, the control unit 106 instructs the target server X to add (install) the new FPGA program, via the network interface 104. Meanwhile, in the case of deleting the FPGA program F-A1.1 from the server X, for example, the control unit 106 instructs the target server X to delete FPGA program F-A1.1, via the network interface 104.

### <Processing of CPU as Substitute During FPGA Program Update>

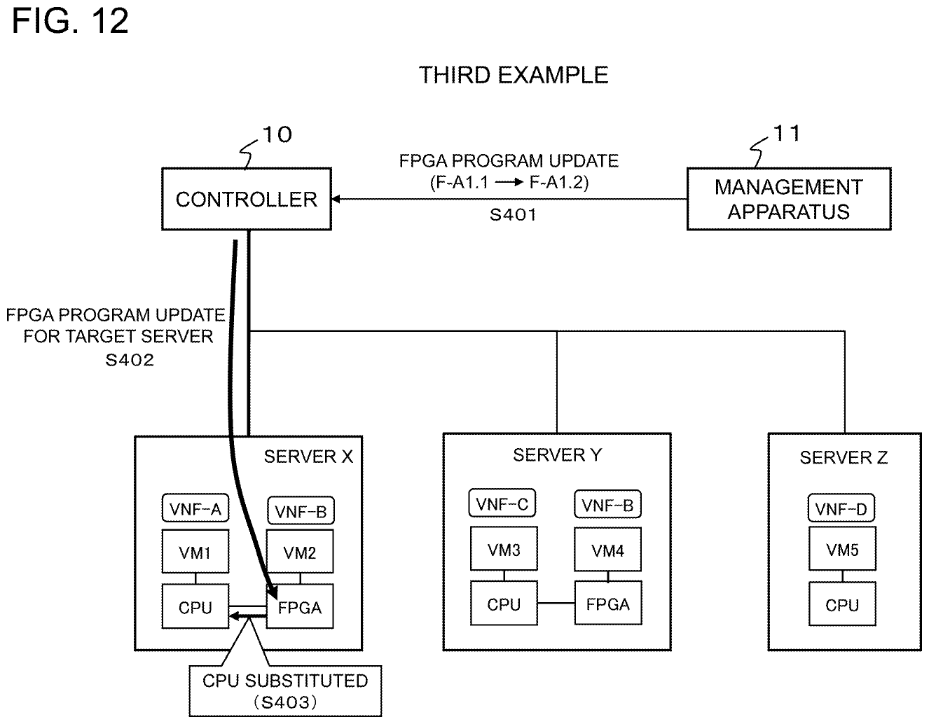

FIG. 12 illustrates another example of FPGA program update control. In FIG. 12, when receiving an instruction to perform version upgrade of the FPGA program F-A1.1 from the management apparatus 11 (operation S401), the controller 10 upgrades the version of the FPGA program of the target server X from F-A1.1 to F-A1.2 (operation S402). At that time, the CPU performs data processing of VM2 that the FPGA has performed, as a substitute for the FPGA (operation S403). Thereby, it is possible to continue data processing during FPGA update without performing temporal migration or the like.

The control for the CPU to perform the data processing of the FPGA as a substitute for the FPGA may be performed autonomously when the server X receives an FPGA program update instruction from the controller 10. Alternatively, the controller 10 may instruct the server X to cause the CPU as the substitute to perform the processing. For example, a processing substitution instruction may be included in an FPGA program update instruction from the controller 10.

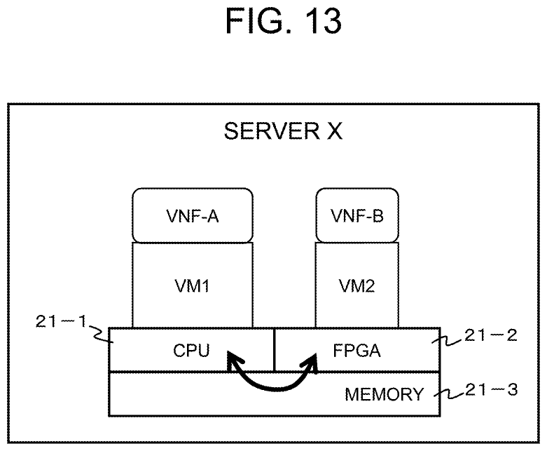

As illustrated in FIG. 13, control to cause the CPU 21-1 to perform data processing performed on the VM2 of the FPGA 21-2 as a substitute for the FPGA 21-2 can be made via a shared memory 21-3, for example.

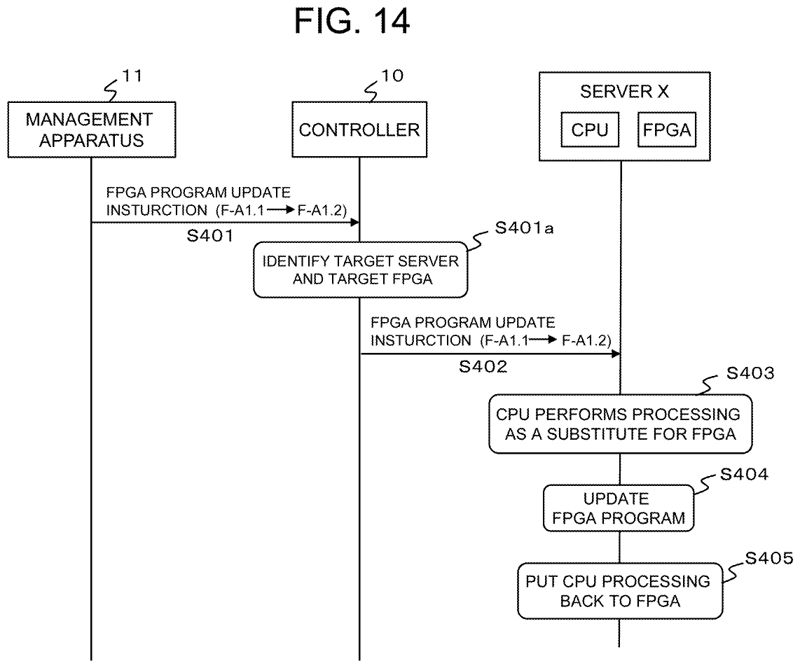

Hereinafter, FPGA program update control as illustrated in FIG. 12 will be described in more detail with reference to FIG. 14.

As illustrated in FIG. 14, when receiving an instruction to perform version upgrade of the FPGA program F-A1.1 from the management apparatus 11 (operation S401), the control unit 106 of the controller 10 refers to the management table of the FPGA management unit 103 to identify the FPGA program F-A1.1 of the server X (operation S401a), and transmits an update instruction to the target server X to upgrade the version of the FPGA program from F-A1.1 to F-A1.2, via the network interface 104 (operation S402).

When the server X receives the FPGA program update instruction from the controller 10, the server X causes the CPU to autonomously perform data processing performed by the FPGA as a substitute for the FPGA. First, data processing of the VM2 performed by the FPGA is autonomously performed by the CPU, resulting in that the CPU performs data processing of VM1 and VM2 (operation S403). Then, update processing is performed with use of the update FPGA program received from the controller 10 (operation S404). When program update on the FPGA is completed, the FPGA takes over the data processing of the VM2 from the CPU and performs it on the updated program F-A1.2 (operation S405). In this way, during the time of version upgrade of the FPGA program, data processing that should be performed by the FPGA during FPGA update is continued by the CPU. Accordingly, the server X is able to update the FPGA program without interrupting the processing.

As described above, the control to cause the CPU to perform data processing performed by the FPGA as a substitute for the FPGA may be performed by the server X autonomously. Alternatively, the controller 10 may perform the control under the initiative of the controller 10 by including a processing substitution instruction in the FPGA program update instruction.

### 1.4) Effect

As described above, according to the network control by the present embodiment, it is possible to identify a VM and/or an FPGA to be updated, with use of a correspondence relation among an FPGA included in a server, a virtual machine (VM) operating on the server, and a VNF implemented by the VM of the server. Thereby, it is possible to perform control such as update of an FPGA program, and addition/update of an FPGA associated with the addition/update of a VM, allowing efficient control of a network including FPGAs.

### 2. Other Exemplary Embodiments

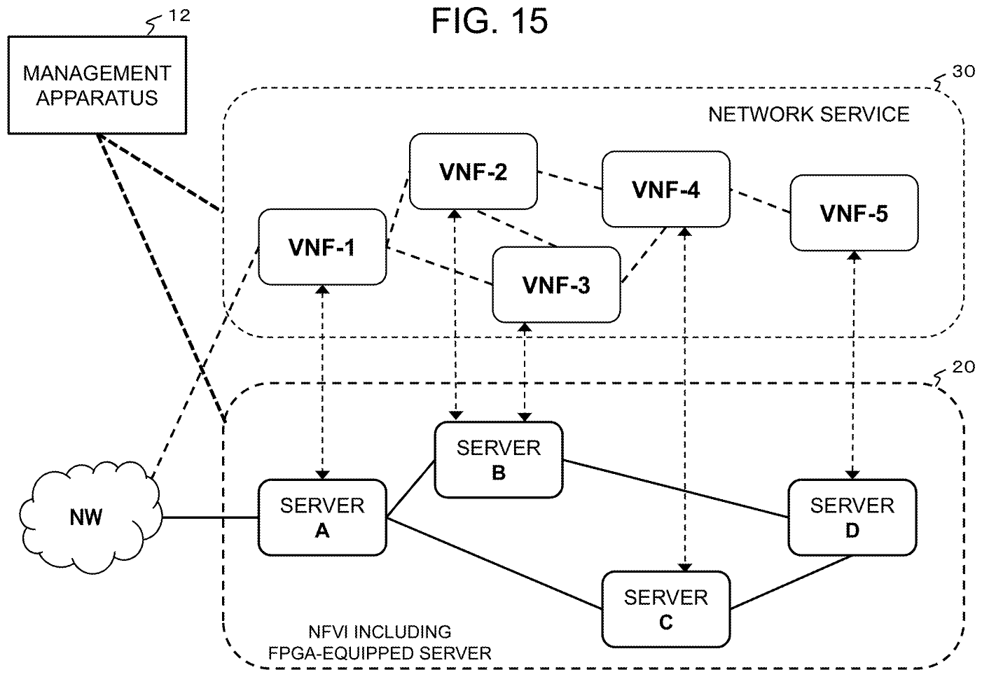

While the aforementioned embodiment illustrates the case where the management apparatus 11 collectively manages a network system via the controller 10, it is also acceptable that a management apparatus in which the management apparatus 11 and the controller 10 are integrated collectively manages a network. For example, as illustrated in FIG. 15, it is also possible that a management apparatus 12 includes functions of the management apparatus 11 and the controller 10, and that the management apparatus 12 collectively manages a network system.

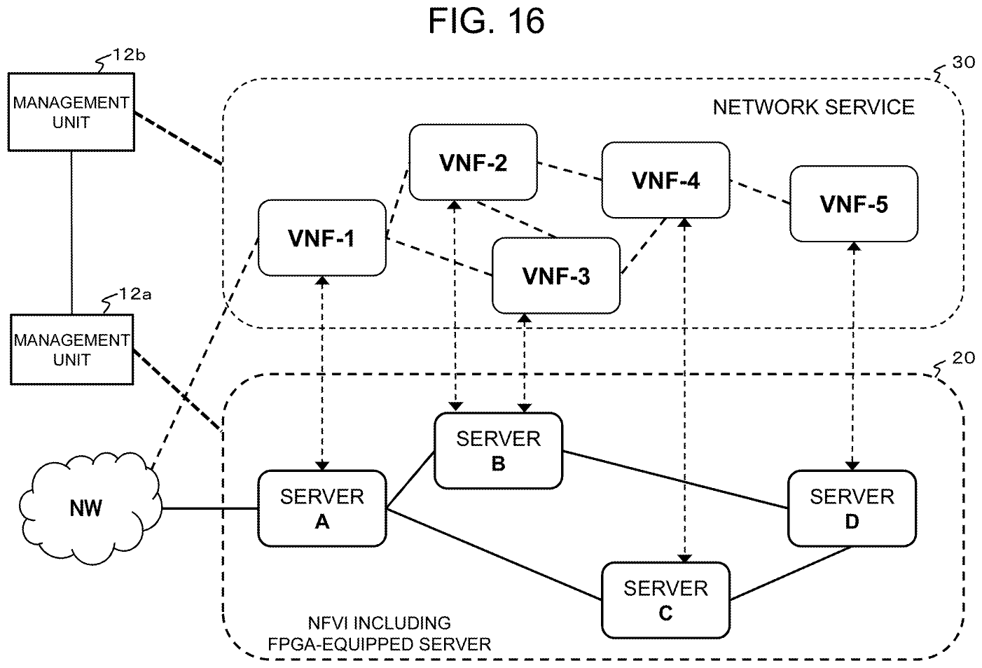

Further, the present invention is not limited to collective management described above. The present invention may have a configuration in which respective layers of a multilayer system are managed by different management units in cooperation with each other. FIG. 16 illustrates an example of such a distributed management system.

As illustrated in FIG. 16, a network system includes a management unit 12a that manages the lower-layer network 20 (VNFI layer) and a management unit 12b that manages the upper-layer network 30 (VNF layer). The management units 12a and 12b manage the lower-layer network 20 and the upper-layer network 30 in cooperation with each other. A management method thereof is the same as that of the exemplary embodiments described above. Accordingly, the description is omitted.

The management units 12a and 12b that manage respective layers may be configured such that individual devices communicably connected with each other perform the management operation of the respective exemplary embodiments in cooperation with each other, or that they perform the management operation under management of a host device. It is also acceptable to have a configuration in which the management units 12a and 12b that manage the respective layers or a host management unit that manages the management units 10a and 10b may be in one management apparatus while being separated functionally.

### INDUSTRIAL APPLICABILITY

The present invention is applicable to a system in which virtual network functions (VNF) are deployed on a network.

### REFERENCE SIGNS LIST

10 controller
11, 12 management apparatus
12a, 12b management unit
20 lower-layer network
21-1 CPU
21-2 FPGA
22-1 CPU
30 upper-layer network
101 network management unit
102 function management unit
103 FPGA management unit
104 network interface
105 management interface
106 control unit
107 program memory
VNF virtual network function

1. A control apparatus for a network including servers on which virtual network functions operate, the control apparatus comprising:
a memory which stores a correspondence relation among a programmable logic circuit included in a server, a virtual machine operating on the server, and a virtual network function implemented by the virtual machine of the server; and
a processor configured to control at least the virtual machine and the programmable logic circuit on which the virtual machine operates, based on the correspondence relation.

2. The control apparatus according to claim 1, wherein
the processor is further configured to perform addition, update, or deletion of the virtual machine or the programmable logic circuit.

3. The control apparatus according to claim 1, wherein
the processor is further configured to update a program of the programmable logic circuit.

4. The control apparatus according to claim 1, wherein
the processor is further configured to cause a central processing unit (CPU) of the server to perform data processing of the virtual machine operating on the programmable logic circuit as a substitute for the programmable logic circuit.

5. The control apparatus according to claim 1, wherein
when the processor updates a program of the programmable logic circuit, the processor is further configured to cause a central processing unit (CPU) of the server to perform data processing of the virtual machine operating on the programmable logic circuit as a substitute for the programmable logic circuit.

6. A control method for a network including servers on which virtual network functions operate, the method comprising:
by a memory, storing a correspondence relation among a programmable logic circuit included in a server, a virtual machine operating on the server, and a virtual network function implemented by the virtual machine of the server, and
by a processor, controlling at least the virtual machine and the programmable logic circuit on which the virtual machine operates, based on the correspondence relation.

7. The control method according to claim 6, further comprising
by the processor, performing addition, update, or deletion of the virtual machine or the programmable logic circuit.

8. The control method according to claim 6, further comprising
by the processor, updating a program of the programmable logic circuit.

9. The control method according to claim 6, further comprising
by the processor, causing a central processing unit (CPU) of the server to perform data processing of the virtual machine operating on the programmable logic circuit as a substitute for the programmable logic circuit.

10. The control method according to claim 6, wherein
by the processor, when updating a program of the programmable logic circuit, causing a central processing unit (CPU) of the server to perform data processing of the virtual machine operating on the programmable logic circuit as a substitute for the programmable logic circuit.

11. (canceled)

12. (canceled)

13. (canceled)

14. (canceled)

15. (canceled)

16. A server controlled by a controller, the server comprising:
a central processing unit (CPU) operable as an operation subject of a virtual machine that implements a virtual network function; and
a programmable logic circuit operable as an operation subject of the virtual machine that implements the virtual network function,
wherein the CPU controls at least the virtual machine and the programmable logic circuit on which the virtual machine operates, in accordance with an instruction from the controller.

17. The server according to claim 16, wherein
the CPU performs addition, update, or deletion of the virtual machine or the programmable logic circuit.

18. The server according to claim 16, wherein
the CPU updates a program of the programmable logic circuit.

19. The server according to claim 18, wherein
during update of the program of the programmable logic circuit, the CPU performs data processing of the virtual machine operating on the programmable logic circuit as a substitute for the programmable logic circuit, in accordance with a CPU processing substitution instruction included in a program update instruction for the programmable logic circuit from the controller.

20. The server according to claim 18, wherein
when the server receives a program update instruction for the programmable logic circuit from the controller, the CPU performs data processing of the virtual machine operating on the programmable logic circuit as a substitute for the programmable logic circuit during update of the program of the programmable logic circuit.

21. (canceled)
